(19) United States
(12) Patent Application Publication
(10) Pub. No.: US 2013/0047101 A1
(43) Pub. Date: Feb. 21, 2013

(54) PERSONAL SERVICE MENU CONSTRUCTION SYSTEM AND METHOD AND PERSONAL SERVICE MENU PROVISION METHOD THEREOF

(71) Applicants: Lih-Shyang Chen, Tainan City (TW); Chih-Ching Yang, Tainan City (TW); Chao-Cheng Chen, Tainan City (TW); Chao-Yu Chen, Tainan City (TW)

(72) Inventors: Lih-Shyang Chen, Tainan City (TW); Chih-Ching Yang, Tainan City (TW); Chao-Cheng Chen, Tainan City (TW); Chao-Yu Chen, Tainan City (TW)

(21) Appl. No.: 13/586,856

(22) Filed: Aug. 15, 2012

(30) Foreign Application Priority Data
Aug. 15, 2011 (TW) 100129028

(51) Int. Cl. G06F 3/01

(52) U.S. Cl. 715/762

(57) ABSTRACT

A personal service menu construction system is provided for an application software to construct a homemade function menu, including: a selection module for setting required function options from a plurality of function options of the application software; an integration module for receiving the function options set by the selection module such that the function options set by the selection module are edited or packaged and integrated as a personal service menu; and a construction module for inputting the personal service menu to the application software. A personal service menu provision method is provided such that the personal service menu can be saved in a storage device and inputted to the same application software of another electronic device.

### BACKGROUND OF THE INVENTION

1. Field of the Invention

The present invention relates to personal service menu construction systems, construction methods, personal service menu provision methods thereof, and, more particularly, to a personal service menu construction system and construction method and the personal service menu provision method for integrating function options.

2. Description of Related Art

Followed by the flourishing development of computer technology, computer application software systems (including computer operation systems) are continuously updated. In order to provide each kind of functions or to satisfy different requirements, when applying software designs, factories would consider to provide various functions for users to use, thereby enhancing functionality of the application software.

Under powerful functions of the current application software, a great variety of operation functions are provided. However, it can merely increase function options or add all possible operation options into the menu while the application software is hard to be customized for coping with various demands. It thus results in complicated menu contents. There are usually many function options under each main classification. Such a multi-level menu is not only inconvenient while searching for specific options but also time-consuming while it needs to be clicked many times even if the location of the options is known. As illustrated in FIG. 1, a schematic diagram of function options in current application software is provided, wherein a function list 1 would be divided into a plurality of classifications 10 while each classification 10 has sub-classification 11 including other function option 100 therein or function option 100. In other words, at present, most application software all put function options of similar function together in the same menu. This is an user interface with function tendency. As a whole, although a plurality of function options are provided for being chosen, it results in inconvenient operation.

For most users, common function can be dozens of kinds, and different application software have no specific rule to function classification. Therefore, it is inconvenient for the user to search or use. Furthermore, the whole operation interface can be regulated while updating. However, the user has to learn new interfaces and even spends more time to searching for function options. In addition, when a specific operation or certain standard operation procedure is performed on software exhibition, teaching and works, a portion of specific functions can be executed to complete the specific operation or certain standard operation procedure. However, these executed functions can be dispersed in different function menus, it easily results in taking too long for exhibition operations or teaching operations or even coming out with no searching result. Therefore, if common function options can be put together, it will be beneficial for software operation utilization.

Hence, it is an issue for persons skilled in the art as to how to provide a function menu convenient for users to execute software application or put common function options together for various applications such as product exhibition or software teaching, so as to increase utilization conveniences of application software.

### SUMMARY OF THE INVENTION

In view of the above disadvantages of the prior art, an objective of the present invention is to provide a personal service menu construction system and construction method and a personal service menu provision method thereof so as to decrease time of searching for required function options in a multi-level menu. Such kind of personal service menu primary for user service requirements is so called as an user interface with service tendency.

In order to achieve the aforementioned objective and other objectives, the present invention provides a personal service menu construction, provided for an application software to construct a homemade function menu, comprising: a selection module for setting required function options from a plurality of function options of the application software; an integration module for receiving the function options set by the selection module such that at least one of the function options set by the selection module is edited or packaged and integrated as a personal service menu; and a construction module for constructing the personal service menu in the application software, wherein options in the personal service menu comprise at least one of automatically executing options, exhibition procedure options or standard working procedure options formed by editing and integrating via the integration module the function options set by the selection module, and the function options set by the selection module packaged and integrated via the integration module.

In an embodiment, the standard working procedure options are configured for arranging the function options set by the selection module in order and integrating the function options set by the selection module in the personal service menu via an editing function provided by the integration module so as to sequentially execute a plurality of original function options of the application software.

In another embodiment, the personal service menu construction system is constructed in an electronic device installed with the application software, and the construction module further comprises a function of outputting the personal service menu while the outputted personal service menu is for being inputted to the same application software of the same or another electronic device.

Further, the present invention provides a personal service menu construction method for constructing a homemade function menu of an application software, comprising the steps of: (1) setting required function options from a plurality of function options of the application software; (2) editing or packaging the set function options so as for the edited set function options or the packaged set function options to be integrated as a personal service menu; and (3) constructing the personal service menu in the application software, wherein the personal service menu comprises at least one of automatically executing options, exhibition procedure options and standard working procedure options formed by the integrated edited set function options and the integrated packaged ser function options.

In an embodiment, the personal service menu of step (1) is a multi-level function menu.

In addition, the present invention further comprises a personal service menu provision method according to the aforementioned personal service menu construction system, the method comprises outputting and saving the personal service menu in a storage device so as to input the personal service menu form the storage device to the same application software of another electronic device, wherein the storage device comprises a cloud server, a hard disk, a multi-media storage device or a thumb disk, and the personal service menu is outputted in combination with data outputted files of the application software.

Compared to the prior art, the present invention provides a personal service menu construction system and method thereof for constructing the original function menu in the application software as the personal service menu. The user can select the function options in the original function menu or record the operating events or function options executed under the set function options so as to construct a new personal service menu. The construction of the service menu does not change the original function menu of the application software. It further puts the common function options together and thus prevents inconvenience of operation or searching during utilization. In addition, the service menu which has been arranged in order can be constructed according to requirements and further applied to function display or teaching example. Further, the personal service menu can be outputted to the same application software of other electronic devices such that other same application software can use the personal service menu. As such, the new service menu formed by integrating common function options or recording the operation or function options executed under the set function options is simpler and more convenient when in use and of great benefit.

### BRIEF DESCRIPTION OF DRAWINGS

FIG. 1 is a schematic diagram of current function options in an application software;

FIG. 2 is a system block diagram of a personal service menu construction system in accordance with the present invention;

FIG. 3 is a flow chart of a personal service menu construction method in accordance with the present invention;

FIG. 4 is an exemplarily schematic diagram of the application of a selection module of the personal service menu construction system in accordance with the present invention;

FIG. 5 is another exemplarily schematic diagram of the application of the selection module of the menu construction system with service tendency in accordance with the present invention;

FIGS. 6A and 6B are schematic diagrams of the application of a generated personal service menu in accordance with the present invention.

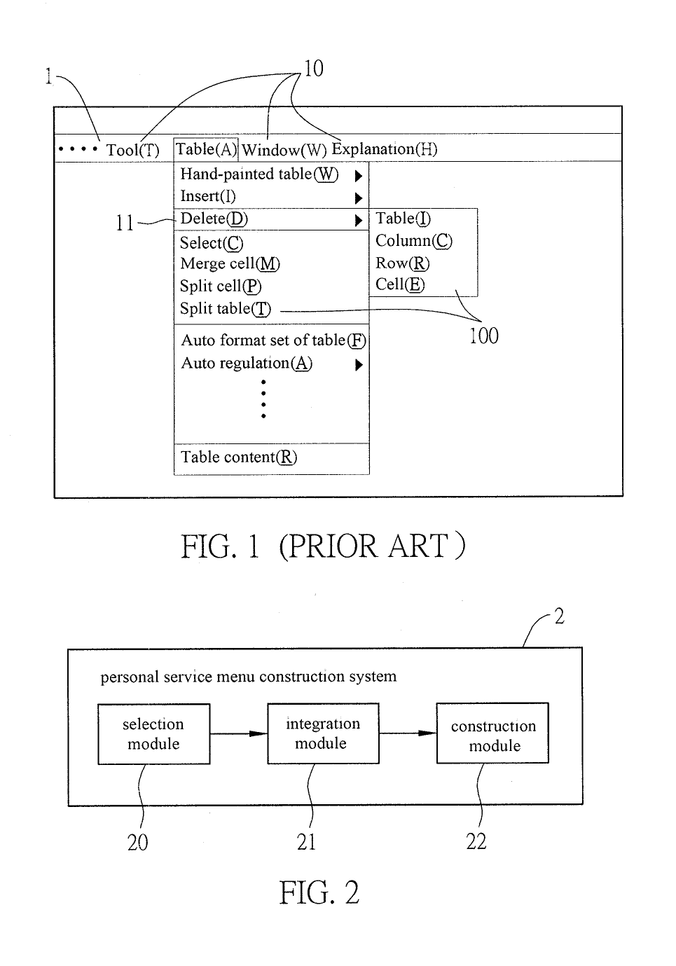

### DETAILED DESCRIPTION OF PREFERRED EMBODIMENTS

The technical contents of the present invention will be illustrated by the following specific embodiments. One having ordinary skill in the art can readily understand other advantages and effects of the present invention from the disclosures of the specification. The present invention can also be implemented or applied in other different embodiments.

As illustrated in FIG. 2, a systematic block diagram of a personal service menu construction system 2 in accordance with the present invention is provided. The personal service menu construction system 2 (hereinafter referred to as “construction system 2”) is provided for a user to construct a personal function menu with respect to an application software operated by the user. The personal function menu is generated by putting required function options together. The construction system 2 of the present invention merely generates the personal service menu meeting the user's own requirements according to their operation requirements and uploads the menu into the application software for the user to use it rather than changing an originally built-in function menu of the application software. The construction system 2 comprises a selection module 20, an integration module 21 and a construction module 22.

The selection module 20 is used to set required function options via selection or recording procedures by the function menu of the application software. Specifically, the selection module 20 is provided for the user to set the required function options, wherein those function options are from the function options in the original function menu of the application software. The required function options can be set by way of selection or recording and are provided for the integration module 21 to integrate them as the personal service menu.

In particular, the selection module 20 is a selection interface capable of listing the function options of the function menu. These function options can be a selection of a single function option or a performance of an operation event to the selected function option or a recording of the function option. The user can use the selection module 20 to select and determine which aforementioned mechanism to use. In other words, in order to allow the user to readily construct the personal service menu, the selection module 20 can be a selection interface such as a dialog window or a setting interface so as to allow the user to readily perform a selection of the required function options.

The integration module 21 is used to receive the function options selected by the selection module 20 and edit or package them so as to integrate them as the personal service menu. First, the user selects the required function options via the selection module 20. At this time, the user can edit or directly package these function options according to requirements. For example, the title of the selected function options can be changed, or the order of the selected function options can be regulated so as to form a consecutive operation procedure. Therefore, by a flexible integration way, the formed personal service menu fits actual utilization.

The construction module 22 is used to input the personal service menu to the application software, wherein the options inside the personal service menu comprise at least one of automatically executing options, exhibition procedure options and standard working procedure options formed by editing and integrating via the integration module 21 the function options set by the selection module 20, and the function options set by the selection module 20 packaged and integrated via the integration module 21. Specifically, the integration module 21 provides an editing function according the user's requirements prior to the input of the personal service menu integrated by the integration module 21 to the application software by the construction module 22. Therefore, except packaged and integrated via the integration module 21, the function options selected by the selection module 20, the menu type of automatically executing options or standard working procedure options provided by the aforementioned editing function. As a result, different application options are made available under different requirements and a user is able to flexibly vary the personal service menu according to his/her requirement.

Next, regarding the aforementioned different menu types of the personal service menu, the objective and content thereof are further illustrated in detail. In particular, the aforementioned packaged and integrated personal service menu refers to selecting original function options of the application software and setting and integrating the selected function options as the personal service menu, wherein the personal service menu can comprise a single option function or an integration of a plurality of option functions.

The automatically executing option is a function option integrated in the personal service menu having automatically executing functions by selecting the function options via the selection 20 or recording operating events or function options executed by the function options set by the user and edited or directly packaged by the integration module 21. Specifically, by recording operating events or function options executed under the selected function options, one option can be integrated and further integrated in the personal service menu. The user can select the option and then at least one function operation is directly executed, herein the described function operation can be the operating procedure of a single function option or a single option formed by recording continuous operating procedure of a plurality of function options. Then, these function options can be sequentially and automatically completed by merely executing the option by the user. For example, a function option may be selected many times, and the function option can be selected many times and set sequentially listed in the personal service menu.

The standard working procedure is that the function options set by the selection module are sequentially arranged via the editing function provided by the integration module and integrated in the personal service menu, so as to sequentially execute the original function options of the plurality of application software. Therefore, the user can arrange the function options according to a performing sequence. Such kind of design of the personal service menu makes it easy for the user to execute each function option according to the required operation sequence. For example, during software exhibition or teaching, certain functions can be executed or specific effects can be displayed. Therefore, it not only allows the user to operate easily but also avoids the problem of searching for multiple functions in the original function menu or even coming out of no search result.

In one embodiment of the present invention, the construction module 22 further comprises outputting the personal service menu so as to input it to the same application software of other electronic devices. Specifically, the construction module 22 is constructed in an electronic device installed with the application software. The user can output the personal service menu by the construction module 22. The outputted personal service menu can be stored in a general storage device, network space or the like, and not limited to a single electronic device, and can be further inputted to the same application of other electronic devices while rendering the user conveniently to apply the personal service menu to other electronic devices. Of course, a single application software can also be inputted to a multiple groups of personal service menus such that required personal service menu can be selected according to different requirements. The inputting action herein, except directly inputting to the application software, inputs the personal service menu to the application software from an external storage device such as a hard disk or network and shows the personal service menu in the application software so as to provide it to the user.

The aforementioned saving way can comprise independently saving the personal service menu as one file or saving it together with user data of the application program in the same file so as to read it together with the user data in the application program or saving it in a near end or distal end data base. In other words, the aforementioned outputted personal service menu can be combined with data outputted file of the application software and then be outputted and be inputted in the application software while executing the data outputted file next time, so as to provide the personal service menu at the same time. Therefore, the personal service menu can be not only outputted in the form of a single file but also outputted in combination of the data outputted file of the application software. As such, when the user executes the data outputted file in the application software, the personal service menu is immediately presented in the application software and can available to be used.

If necessary, the personal service menu can be combined with user identity for use in an application software regarding the verification of user authorization. Since the application software can be inputted with personalized service menus of multiple users, and different users tend to have different requirements, the personal service menus are certainly different. Therefore, after each personal service menu is combined with the user identity, when the user logs in the application software, the application software can provide the personalized service menu required by the user according to the user identity.

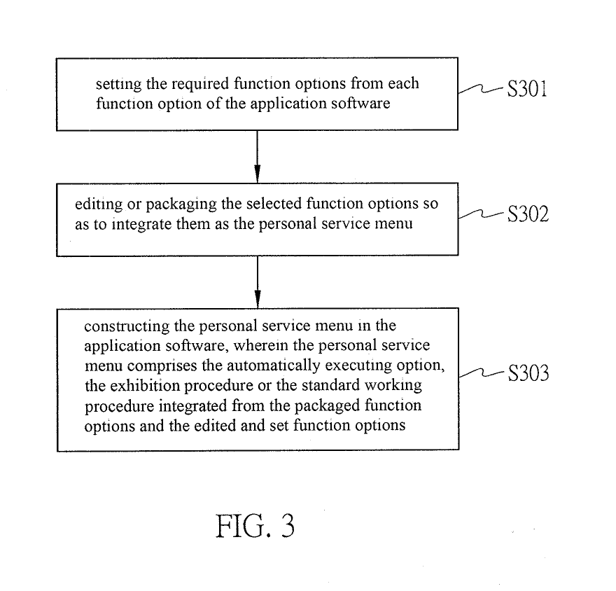

Next, in cooperation with the menu construction system with service tendency illustrated in FIG. 2, the following will illustrate the flow chart of the menu construction method with service tendency in accordance with the present invention, as illustrated in FIG. 3.

In step S301, setting the required function options from the function menu of the application software comprises selecting required options or selecting function options executed by the user via a recording procedure. Specifically, the user can list all function options for the user to click and check via the selection interface, such as the dialog window or select the required function options and then set via dragged dialog window. The required function options can be the function options from the original function menu of the application software or can be generated by operating events or function options executed under function options selected by the recording procedure. Next, step S302 is entered.

In step S302, the selected function options are edited or packaged and integrated as the personal service menu. Specifically, the user can edit or directly package the selected function options according to the requirements. The editing herein refers to changing the title of the function options or the order thereof such that the title thereof complies with personal habits and is easier to be understood or to regulate the sequence in consideration with the order. The editing comprises editing the title of the service menu and editing the option title in the personal service menu. That is, the title of the personal service menu can be modified and the title of the function option therein can also be modified. The direct packaging herein refers to merely packaging the set function options as function options processed by an event without executing the aforementioned editing process.

The mentioned personal service menu in step S302 is a multi-level function menu. If necessary, the generated personal service menu can be the multi-level function menu. The personal service menu can comprise a plurality of function options. In order to consider the function options in the form of hierarchy structure, the personal service menu is permitted to be multi-level. Next, step S303 is entered.

In step S303, it constructs the personal service menu is constructed in the application software. The personal service menu comprises the function options, the automatically executing options, the exhibition procedure options, the standard working procedure options, and the like. That is, the personal service menu generated in step S302 is inputted to the application software, and the personal service menu can generate different application situations such as a single function option, automatically executing options for executing the recording procedure options, the exhibition procedure options, or the standard working procedure options for consecutively executing a number of function options according to the prior integration result. Therefore, the user can construct the personal service menu according to personal requirements.

Further, the mentioned standard working procedure options in step S303 are configured to arrange the function options in order via step S302 so as to sequentially execute them according to the order of the function options. In other words, during the integration in step S302 at least one of the selected function options is sequentially arranged such that the user can achieve the exhibition or teaching effects based on executing the function options.

The mentioned automatically executing option in step S303 integrates and packages the contents of the personal service menu so as to automatically and sequentially execute all function options in the personal service menu. Different from the way of the user's clicking and executing the option, this automatically executing option can automatically execute recorded operating events or function options and then can continuously complete all option function.

Regarding the aforementioned operating events or function options, only the option of recording the function option rather than parameters is involved. For example, merely recording the function of selecting “font” while setting the size of the font is further inputted by the user for being used for the standard working procedure. In addition, it can further comprise the function of selecting “font” while recording the parameter of the size of the font such that no additional inputting action is needed, and thus is suitable for software exhibition. For example, when a certain function is executed, some parameters such as font size and the like need to be set, and the user can use the record of operating events if the user is willing to record the function options and these parameters at the same time. If only the function options are to be recorded, the parameters will be interactively set when the user clicks the function options, and at this time, it can choose to record only the function option.

In addition, step S303 further comprises outputting the personal service menu so as to input it to the same application software of other electronic devices. Specifically, in order to make it convenient for the user to use the personal service menu made by himself/herself in different electronic devices, the function of outputting the personal service menu and inputting it into other electronic device having the same application software is provided such that the application of the personal service menu constructed by the user himself or herself is more global and has better maneuverability and mobility. Specifically, the outputting way refers to that the personal service menu in the form of a single file and saved in the near end, portable or far end devices or apparatuses. Besides, the personal service menu can be outputted in combination with the data outputted file of the application software. That is, the user can directly execute the outputted data outputted file. At this time, the application software comprises the personal service menu used by the data outputted file for the user without inputting the personal service menu.

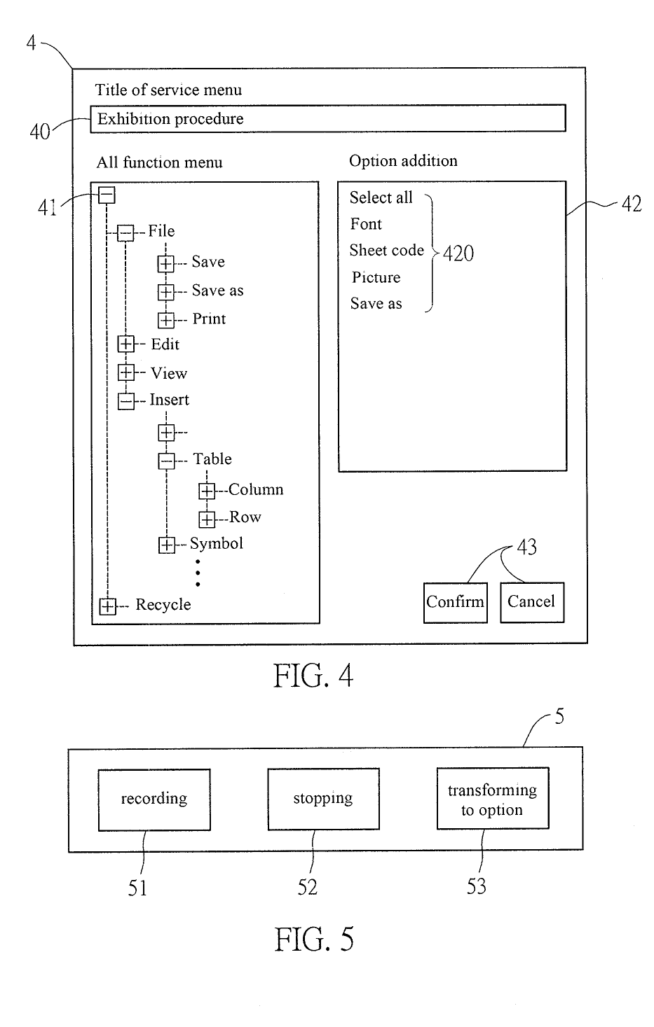

Next, as illustrated in FIG. 4, an exemplarily schematic diagram of the application of the selection module of the personal service menu construction system in accordance with the present invention is provided. As illustrated, when the user would like to construct the personal service menu, the system can provide the selection interface 4 comprising three parts. As illustrated, a key-in frame 40 of “title of the service menu” is used for the user to fill the title personal service menu to be constructed. With respect to all function manus provided by the application software, the selection module 4 further provides a display frame 41 having the contents of all function manus. That is, the contents of all function manus list all function manus and all function options thereof in the application software. The user can add a display frame 42 provided by the selection module 4 in a way of selecting or dragging and confirm the operation and selection results via function bottoms 43. In particular, the contents of all function manus are illustrated in a way of a tree structure so as to continuously unfold or fold the multi-level function manus. And the function options 420 present in the display frame 42 are the function options selected by the user.

Further, as illustrated in FIG. 5, another exemplarily schematic diagram of the selection module of the menu construction system with service tendency in accordance with the present invention is provided. The selection module of this embodiment records the operating event procedures or function options executed under the selected function options. As illustrated, the operation interface 5 provides a “recording” function button 51, a “stopping” function button 52, a “transforming to option” function button 53 and the like button of selecting and operating to record the operating event procedure or the function options. After the user executes the “recording” function button 51, and before the user selects to execute the “stopping” function button 52, the system would record the operating events or function options under the follow-up selected function options. Then, the user selects the “transforming to option” function button 53 to transform the previously recorded operating events to the function options for being edited or packaged by the integration module and thus being integrated as the personal service menu.

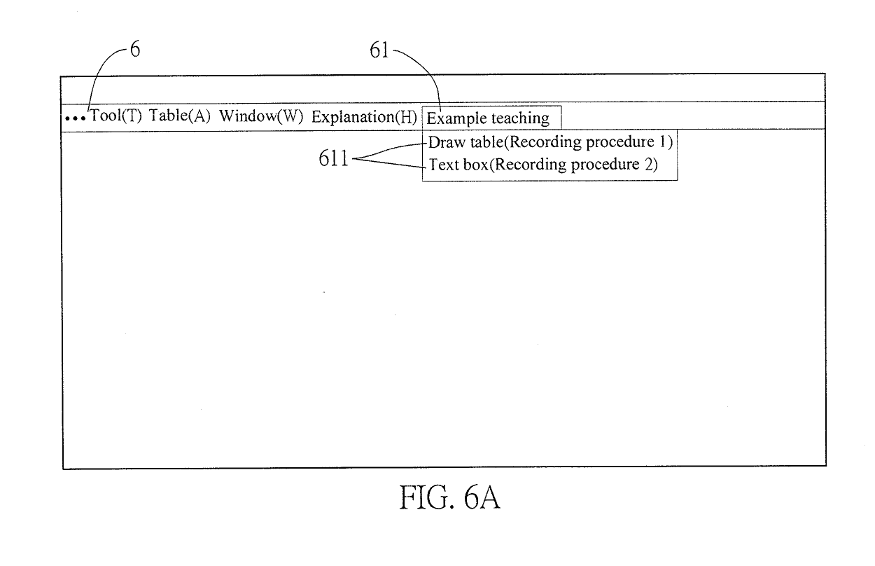

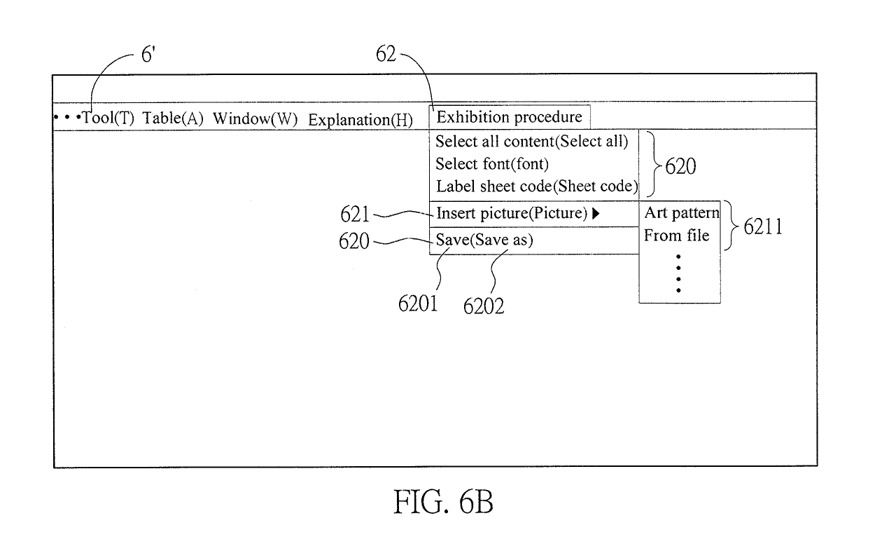

After the operating events executed under the selected function options are recorded via the operation interface 5 illustrated in FIG. 5, the generated personal service menu is illustrated in FIG. 6, wherein a personal service menu 61 constructed by the user is illustrated in a function list 6, and the title thereof can be altered according to requirements. As illustrated, options 611 are correspondingly generated in the personal service menu 61 according to the previously recording operation procedure. One of these options 611 is a continuous operating event of “drafting table,” and the original title of the function is inside the bracket in FIG. 6. After the user clicks the option of “drafting table” 611, the system would automatically execute functions and thus generate recorded operating procedures and results, for instance, the application software providing a document editing function. When the user wants to perform an editing process of font size of documents via the application software, the user can record the following operating events: the user unfolding the function option of “format” in the tool list, showing up the option belonging to the function of “format” such that the user can select the sub-function of “font” in the personal service menu, and then the option belonging to the sub-function of “font” is showed up. Accordingly, the user can set the font size or the like for operating event in the option of the sub-function.

In addition, the selection of the function options is performed via the selection interface 4 illustrated in FIG. 4. The generated personal service menu is illustrated in FIG. 6, wherein the personal service menu 62 constructed by the user is illustrated in the function list 6′, and the title thereof can be altered according to requirements. As illustrated, the personal service menu 62 correspondingly generates the option 620 according to the previous selection. Each option 620, 6211 can be executed alone or can be ordered during integration procedure so as to be sequentially executed by the user to achieve certain effects. As illustrated, the personal service menu 62 provides teaching steps of regulating fonts, adding page numbers, inserting pictures, saving and the like. As such, an operator does not need to additionally search for each function option to be executed in the function list 6′. It not only makes it convenient to be exhibited but also reduces mistake operations.

In particular, the personal service menu 62 comprises the single option 620 and further a sub-classification 621. The sub-classification 621 has other options 6211. That is, in order to cooperate with the user, the personal service menu 62 can be constructed as the multi-level function menu. Further, as illustrated in the option 620 in the personal service menu 62, the former “saving” is a title edited by the user and can be altered at any time so as to comply with the user's habits and benefits to the illustration while “saving as” in the bracket is a title of the original function option of the application software. Even if other users use the same personal service menu to perform operation, it will let everybody know the original title of the option rather than result in incomprehensible situations.

In addition, a personal service menu provision method in accordance with the present invention is illustrated in cooperation with the aforementioned system architecture illustrated in FIG. 2. It outputs the personal service menu and saves it in the storage device. The personal service menu can be inputted in the electronic device having the same application software. That is, the personal service menu can be alternatively used in the same application software. The personal service menu can be inputted in the aforementioned electronic device having the same application software by saving the personal service menu via storage devices such as a cloud service, a hard disk, a multi-media storage or a thumb disk. As such, when the electronic device executes the application software, the personal service menu can be used under the application software. Therefore, the personal service menu can be used in a way of not only using the electronic device constructed in the personal service menu but also using the personal service menu saved from other places to the near end electronic device. For example, after outputting and saving the personal service menu constructed by the aforementioned system architecture illustrated in FIG. 2 in a personal computer and then imputing the personal service menu to a public computer, an exhibition computer or a teaching computer and the like electronic device having the same application software, the personal service menu can be used so as to broaden the application.

In conclusion, the personal service menu construction system and method and the personal service menu provision method thereof in accordance with the present invention generate the personal service menu by putting common function options together or recording the operating events or function options executed under the selected function options. Not only the user can put common function together to reduce the procedure and time of researching and operation but also the personal service menu can be further applied to software exhibition or teaching. Putting the required function together not only makes it convenient for the user to operate but also can be served as the standard working procedure. Other users can achieve the specific effects by merely executing it according to the order of the personal service menu, thereby enhancing the benefit. In addition, the personal service menu generated in accordance with the present invention is not limited to be used in the aforementioned single electronic device illustrated in FIG. 3. The present invention further provides the outputting process of the personal service menu for being inputted to the different electronic devices having the application software such that the personal service menu can be carried and used.

The foregoing embodiments merely exemplarily illustrate the principles and effects of the present invention instead of limiting the scope of the present invention. The foregoing embodiments can be modified and varied by one having ordinary skill in the art without violating the spirits and scope of the present invention. Hence, the claimed scope of the present invention shall be listed as the appended claims.

What is claimed is:

1. A personal service menu construction system, provided for an application software to construct a homemade function menu, comprising:
a selection module for setting required function options from a plurality of function options of the application software;
an integration module for receiving the function options set by the selection module such that at least one of the function options set by the selection module is edited or packaged and integrated as a personal service menu; and
a construction module for constructing the personal service menu in the application software, wherein options in the personal service menu comprise at least one of automatically executing options, exhibition procedure options and standard working procedure options formed by formed by editing and integrating via the integration module the function options set by the selection module, and the function options set by the selection module packaged and integrated via the integration module.

2. The personal service menu construction system of claim 1, wherein the standard working procedure options are configured for arranging the function options set by the selection module in order and integrating the function options set by the selection module in the personal service menu via an editing function provided by the integration module so as to sequentially execute a plurality of original function options of the application software.

3. The personal service menu construction system of claim 1, which is constructed in an electronic device installed with the application software, and wherein the construction module further comprises a function of outputting the personal service menu while the outputted personal service menu is for being inputted to the same application software of another electronic device.

4. The personal service menu construction system of claim 1, wherein the selection module performs setting by selecting or recording the function options or by recording operating events generated under operation of the function options.

5. A personal service menu construction method for constructing a homemade function menu of an application software, comprising steps of:
(1) setting required function options from a plurality of function options of the application software;
(2) editing or packaging the set function options so as for the edited set function options or the packaged set function options to be integrated as a personal service menu; and
(3) constructing the personal service menu in the application software, wherein the personal service menu comprises at least one of automatically executing options, exhibition procedure options and standard working procedure options the by integrated edited the set function options, and the integrated packaged set function options.

6. The personal service menu construction method of claim 5, wherein setting of the step (1) refers to selecting or recording the function options or recording operating events generated under operation of the function options.

7. The personal service menu construction method of claim 5, wherein the standard working procedure options of step (3) are configured to arrange the set function options in order and integrates the plurality of set function options in the personal service menu via the editing process of step (2) so as to sequentially execute a plurality of original function options of the application software.

8. The personal service menu construction method of claim 5, wherein the personal service menu is outputted in combination with data outputted file of the application software.

9. The personal service menu construction method of claim 5, further comprising a step of providing the personal service menu by outputting and saving the personal service menu in a storage device so as to input the personal service menu from the storage device to an electronic device having the same application software.

10. A personal service menu provision method for applying the personal service menu construction system of claim 1 to construct a homemade function menu of an application software, comprising outputting and saving the personal service menu in a storage device so as to input the personal service menu from the storage device to an electronic device having the same application software.
